(19) United States
(12) Patent Application Publication
(10) Pub. No.: US 2022/0075025 A1
(43) Pub. Date: Mar. 10, 2022

(54) Methods and Apparatus for Detecting Precipitation and Clearing Precipitation from Sensors

(71) Applicant: Nuro, Inc., Mountain View, CA (US)

(72) Inventors: Peter Jon Kardassakis, Mountain View, CA (US); Jingqing Huang, San Mateo, CA (US)

(73) Assignee: Nuro, Inc., Mountain View, CA (US)

(21) Appl. No.: 17/405,938

(22) Filed: Aug. 18, 2021

Related U.S. Application Data
(60) Provisional application No. 63/074,804, filed on Sep. 4, 2020.

(51) Int. Cl. G01S 7/40; G01S 13/931; G01S 13/86; B60W 60/00

(52) U.S. Cl. CPC G01S 7/4043; G01S 13/931; G01S 13/865; B60W 2420/42; B60W 60/001; B60W 2420/52; B60W 2555/20; G01S 13/867

(57) ABSTRACT

In one aspect, a vehicle includes a sensor system, the sensor system including a radar system, the radar system configured to collect a first set of data. The vehicle also includes a clearing system and a detection arrangement. The clearing system is configured to clear at least one surface associated with the sensor system. The detection arrangement arranged to determine when the first set of data indicates a presence of precipitation; wherein when the detection arrangement determines at least that the first set of data indicates the presence of precipitation, the detection arrangement causes the clearing system to activate to clear the at least one surface.

### PRIORITY CLAIM

This patent application claims the benefit of priority under 35 U.S.C. § 119 to U.S. Provisional Patent Application No. 63/074,804, filed Sep. 4, 2020 and entitled “Methods and Apparatus for Detecting Precipitation and Clearing Precipitation from Sensors,” which is incorporated herein by reference in its entirety.

### TECHNICAL FIELD

The disclosure relates to autonomous vehicles. More particularly, the disclosure relates to efficiently detecting the presence of precipitation and taking measures to clear precipitation from sensors used to facilitate the autonomous operation of vehicles.

### BACKGROUND

Systems which enable a vehicle to operate autonomously are often exposed to environmental such as precipitation, e.g., rainfall or snowfall. For example, sensors such as cameras, radar units, and lidar units which are used to enable autonomous vehicles to operate are generally exposed to the environment while the autonomous vehicles drive or otherwise travel. When a sensor is subjected to precipitation, the performance of the sensor may be compromised. When the performance of a sensor on an autonomous vehicle is compromised, the overall performance of the autonomous vehicle may be adversely affected.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a block diagram representation of a radar system, e.g., radar system 326 of FIG. 3, in accordance with an embodiment.

FIG. 4B is a block diagram representation of a radar system with a precipitation detection arrangement in accordance with an embodiment.

FIG. 4C is a block diagram representation is a block diagram representation of a radar system and a computing arrangement which includes a precipitation recognition arrangement in accordance with an embodiment.

FIG. 5A is a diagrammatic representation of a radar system, e.g., radar system 326 of FIG. 3, and a sensor clearing system in accordance with an embodiment.

FIG. 5B is a diagrammatic representation of a radar system, a computing arrangement, and a sensor clearing system in accordance with an embodiment.

FIG. 6 is a process flow diagram which illustrates a method of utilizing a radar system to detect a presence of precipitation and to activate a sensor clearing system in accordance with an embodiment.

FIG. 7 is a process flow diagram which illustrates a method of utilizing a radar system to detect a lack of precipitation in accordance with an embodiment.

FIG. 8 is a block diagram representation of a precipitation recognition arrangement, e.g., precipitation recognition arrangement 458 of FIG. 4C, in accordance with an embodiment.

FIG. 9 is a process flow diagram which illustrates a method of obtaining signatures for comparison purposes in accordance with an embodiment.

FIG. 10 is a process flow diagram which illustrates a method of identifying whether data collected from a radar system is indicative of a presence of precipitation in accordance with an embodiment.

FIG. 11 is a process flow diagram which illustrates a method of using a radar system as part of an overall system which activates sensor clearing when precipitation is present in accordance with an embodiment.

### DESCRIPTION OF EXAMPLE EMBODIMENTS

### General Overview

According to one aspect, a vehicle includes a sensor system, the sensor system including a radar system, the radar system configured to collect a first set of data. The vehicle also includes a clearing system and a detection arrangement. The clearing system is configured to clear at least one surface associated with the sensor system. The detection arrangement arranged to determine when the first set of data indicates a presence of precipitation; wherein when the detection arrangement determines at least that the first set of data indicates the presence of precipitation, the detection arrangement causes the clearing system to activate to clear the at least one surface. In one embodiment, the vehicle is an autonomous or semi-autonomous vehicle and includes a navigation system configured to cooperate with the sensor system to enable the vehicle to operate autonomously or semi-autonomously.

According to another aspect, a platform includes a vehicle and a detection arrangement. The vehicle includes a sensor system, the sensor system including a radar system configured to collect a first set of data. The vehicle also includes a clearing system, the clearing system configured to clear or substantially clean at least one surface associated with the sensor system. The detection arrangement is arranged to determine when the first set of data indicates a presence of precipitation. When the detection arrangement determines that at least the first set of data indicates the presence of precipitation, the detection arrangement causes the clearing system to activate to clear the at least one surface. In one embodiment, the detection arrangement is configured to process the first set of data to identify a first signature, and the detection arrangement determines that the first set of data indicates the presence of precipitation when the first signature approximately matches a second signature that is arranged to indicate an existence of precipitation.

According to still another aspect, a method includes collecting a first set of data from a radar system, the radar system being a part of a sensor system associated with a vehicle, and determining whether the first set of data indicates a presence of precipitation. The method also includes activating a clearing system when it is determined that at least the first set of data indicates the presence of precipitation, wherein activating the clearing system causes a surface associated with the sensor system to be cleared. In one embodiment, the radar system includes at least one frequency-modulated-continuous-wave (FMCW) radar unit.

In one embodiment, a radar system that is utilized for automotive purposes may is used to detect precipitation or, more generally, weather. The precipitation, e.g., rain or snow, is detected substantially in real-time, or when the precipitation is in the vicinity of the radar system. When the radar system determines that precipitation is currently occurring, the radar system may cause a sensor clearing system to clear, or to otherwise clear, surfaces of a sensor which may be adversely affected by the presence of precipitation.

### DESCRIPTION

As the use of autonomous vehicles such as autonomous delivery vehicles increases, the ability for the vehicles to operate safely is becoming ever important. When the performance of sensors on a vehicle is compromised, the ability for the vehicle to operate safely may be compromised. For example, precipitation or debris on the surface of a sensor may compromise the operation of the sensor and, hence, the vehicle on which the sensor is mounted. Precipitation may include, but is not limited to including, rain drops, snowflakes, sleet, and/or hail. Debris may include, but is not limited to including, dirt, dust, leaves, grass, etc.

Providing a clearing mechanism which clears or otherwise clears precipitation or debris from the surface of a sensor reduces the effect of precipitation or debris on the performance of the sensor. As a result, the likelihood that a vehicle which uses the sensor may operate safely may be increased. The clearing mechanism may be efficiently deployed or activated when precipitation or debris is detected. In one embodiment, a radar system on a vehicle may be used to determine when precipitation or debris such as particulate matter is present in the sensing field or field of view of the radar system. When the radar system identifies the presence of precipitation or debris, the radar system may cause a clearing mechanism to be activated to clear the precipitation or debris off of at least one surface of a sensor.

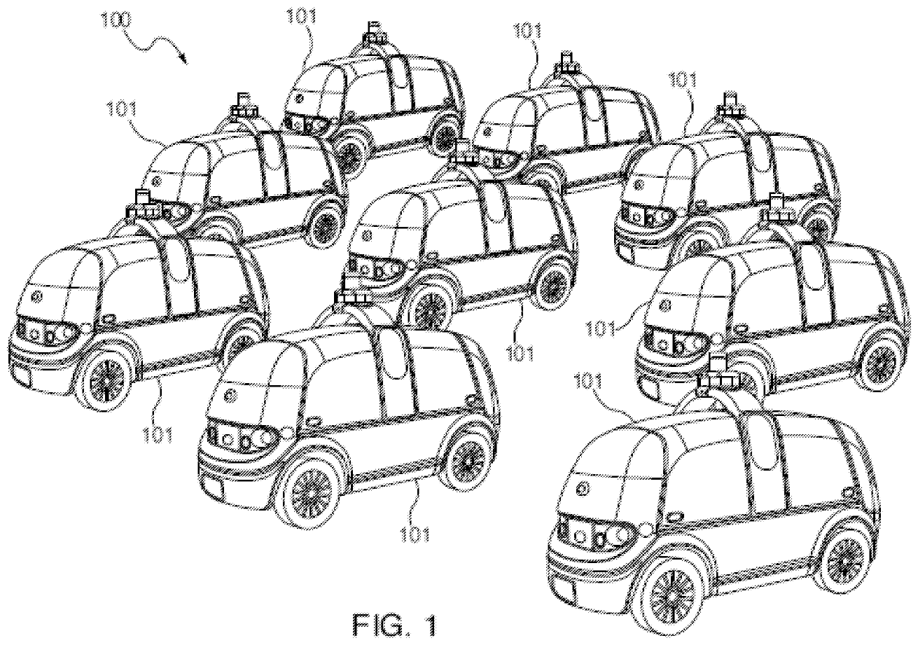

An autonomous vehicle which includes a clearing system may be part of a fleet of autonomous vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

A sensor pod 110 may be part of an overall sensor system associated with autonomous vehicle 101. Sensor pod 110 may generally include an automotive radar system which, in one embodiment, may be used to detect the presence of precipitation. Sensor pod 110 may also include a clearing system configured to clear surfaces associated with sensors in sensor pod 110 when the automotive radar system detects the presence of precipitation.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

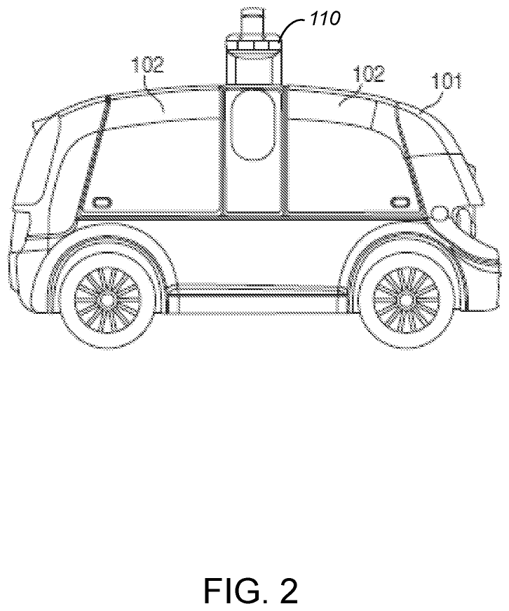

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

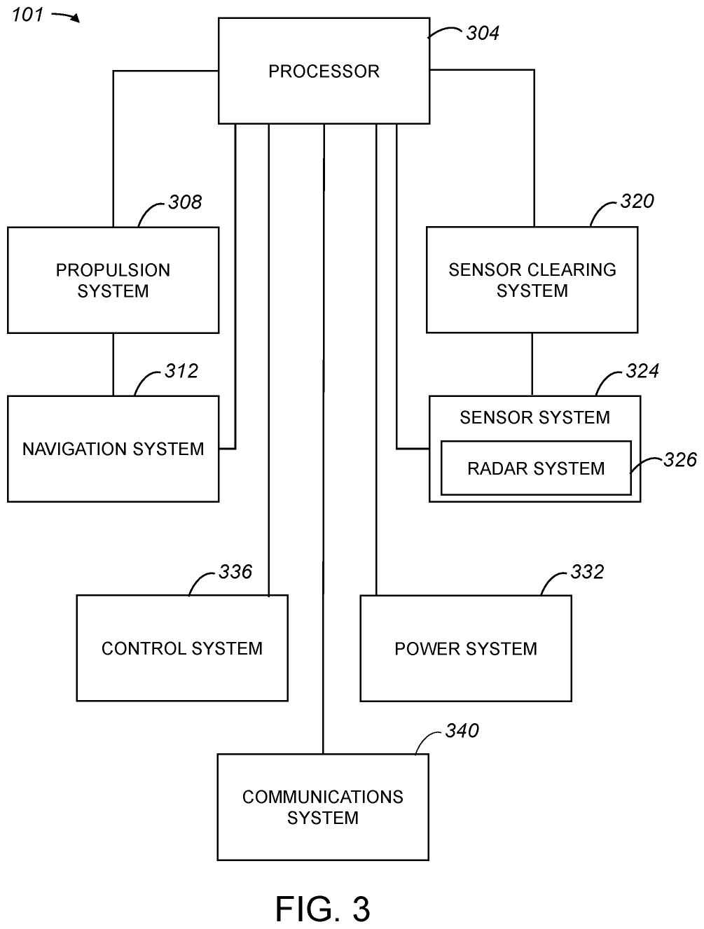

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101. In the described embodiment, vehicle 101 includes a sensor clearing system 320.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. In one embodiment, sensor system 324 includes a radar system 326 that is arranged to collect information to cause a determination of whether there is precipitation in the substantially immediate vicinity of vehicle 101. Radar system 326 may include one or more radar units.

A sensor clearing system 320 is configured to clear surfaces of sensors included in sensor system 324, e.g., external surfaces of sensors that are exposed to a surrounding environment of vehicle 101. In one embodiment, sensor clearing system 320 may be triggered to substantially activate to clear surfaces when radar system 326 detects the presence of precipitation or debris such as particulate matter. Sensor clearing system 320 may be configured to clear or effectively clean surfaces of sensors using a variety of different methods including, but not limited to including, effectively blowing precipitation or debris off of the surfaces, suctioning precipitation or debris off of the surfaces, wiping precipitation or debris off of the surfaces, causing precipitation or debris to substantially evaporate, and/or washing precipitation or debris off of the surfaces.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

When an automotive radar system such as radar system 326 detects the presence of precipitation, radar system 326 causes sensor clearing system 320 to substantially activate to clear precipitation from surfaces of sensors included in sensor system 324. Radar system 326 may be any suitable radar system, e.g., a frequency modulated continuous wave (FMCW) radar system, which is capable of detecting objects such as pedestrians, vehicles, and other obstacles. Other suitable radar system may include but are not limited to including, phase modulated continuous wave (PMCW) systems. Radar system 326 is generally also capable of determining a distance from radar system 326 to an object, as well as a relative velocity of the object. As will be appreciated by those skilled in the art, frequency ranges of radio waves associated with automotive radar system may generally be in the approximately twenty-four GigaHertz (GHz) band and the approximately seventy-seven GHz band. A twenty-four GHz band may generally be associated with a short-range radar arranged to detect objects at distances of up to approximately 100 meters, while a seventy-seven GHz band may generally be associated with a long-range radar arranged to detect objects at distances of up to approximately 250 meters.

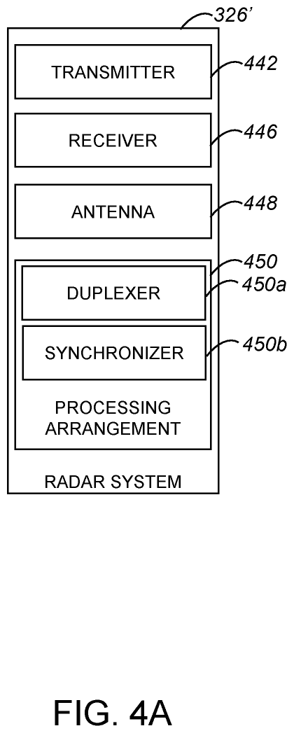

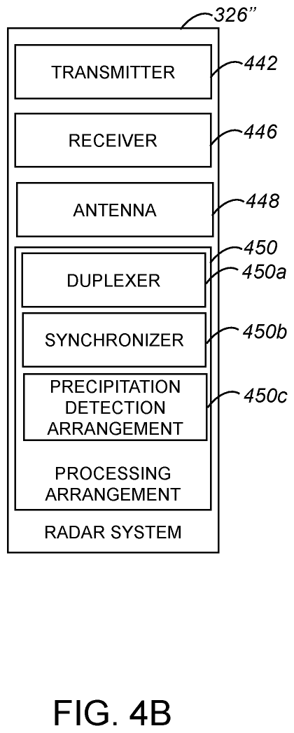

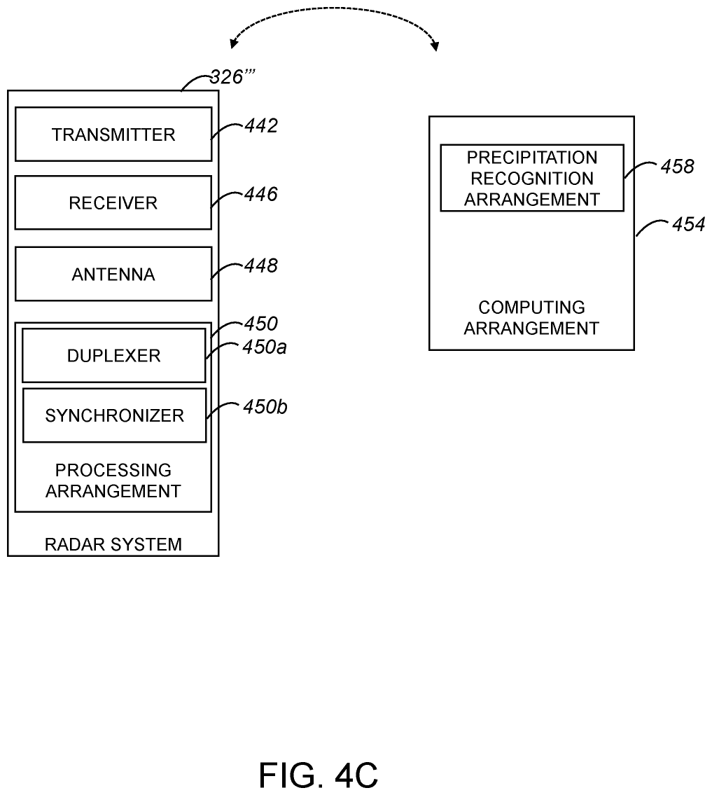

FIG. 4A is a block diagram representation of a radar system, e.g., radar system 326 of FIG. 3, in accordance with an embodiment. Radar system 326′, which is suited for use to support the autonomous operations of an autonomous vehicle such as vehicle 101 of FIGS. 2 and 3, includes at least one transmitter 442, at least one receiver 445, and at least one processing arrangement 450. In one embodiment, each transmitter 442, receiver 445, and processing arrangement 450 may effectively form a radar unit (not shown) within radar system 326′ such that radar system 326 may include more than one radar unit.

Transmitter 442, which may apply a signal or waves to antenna 448, is configured to transmit radio waves, as for example waves in an approximately twenty-four GHz band and/or in an approximately seventy-seven GHz band. Receiver 446, which may utilize antenna 448 to receive a signal or waves, is arranged to receive or to otherwise obtain waves which have reflected off of the surface of an object (not shown). Processing arrangement 450 includes hardware and/or software, and is generally arranged to process waves received by receiver 446 in order to identify where an object (not shown (is located, how far away the object is from radar system 326′, a direction in which the object is moving, and/or how fast the object is moving. In one embodiment, processing arrangement 450 includes a duplexer 450a and a synchronizer 450b. Duplexer 450a enables transmitter 442 and receiver 446 to substantially share antenna 448 for transmitting and receiving purposes. Synchronizer 450b is configured to substantially control and provide timing associated with the operations of radar system 326′.

When a radar system is used to detect precipitation in the vicinity of the radar system, or to detect current precipitation within a field of view of the radar system, the radar system may either include precipitation detection capabilities, or may be in communication with a computing arrangement that provides precipitation detection capabilities. FIG. 4B is a block diagram representation of a radar system with a precipitation detection arrangement in accordance with an embodiment. Radar system 326″ includes transmitter 442, receiver 446, antenna 448, and processing arrangement 450. Processing arrangement 450 includes duplexer 450a, synchronizer 450b, and a precipitation detection arrangement 450c. Precipitation detection arrangement 450c is configured to obtain information from receiver 446, and to substantially analyze or to otherwise process the information to determine whether the information indicates the presence of precipitation. In one embodiment, precipitation may be detected as objects of a particular size which move in a particular direction and with a velocity in a particular range. It should be appreciated that historical data may be leveraged by precipitation detection arrangement 450c to facilitate the identification of precipitation using radar system 326″.

FIG. 4C is a block diagram representation is a block diagram representation of a radar system and a computing arrangement which includes a precipitation recognition arrangement in accordance with an embodiment. Radar system 326′″ includes transmitter 442, receiver 446, antenna 448, and processing arrangement 450. Processing arrangement 450 includes duplexer 450a and synchronizer 450b.

A computing arrangement 454 includes a precipitation recognition arrangement 458 that is arranged to use data obtained from radar system 326′″ to determine whether precipitation is detected by radar system 326′″. Computing arrangement 454 may be located on a vehicle (not shown) along with radar system 326′″, or computing arrangement 454 may be located at a remote location. It should be appreciated that when computing arrangement 454 is remote with respect to radar system 326′″, information may be shared between computing arrangement 454 and radar system 326′″ using a communications system such as communications system 340 of FIG. 3. Enabling communication when computing arrangement 454 is remote with respect to radar system 326′″ may include, but is not limited to including, network communications such as Wi-Fi or Bluetooth communications, 3G/4G/5G communications, and/or LTE communications.

Together, radar system 325′″ and computing arrangement 454 may be a platform or part of a platform. For example, a vehicle (not shown) on which radar system 325′″ is mounted may be part of an overall system or platform which also includes computing arrangement 454.

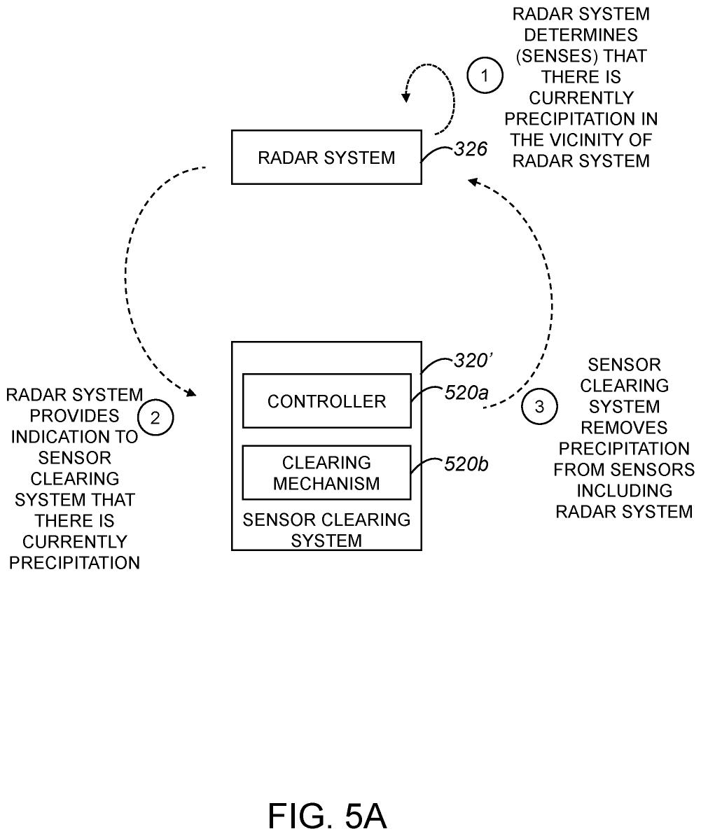

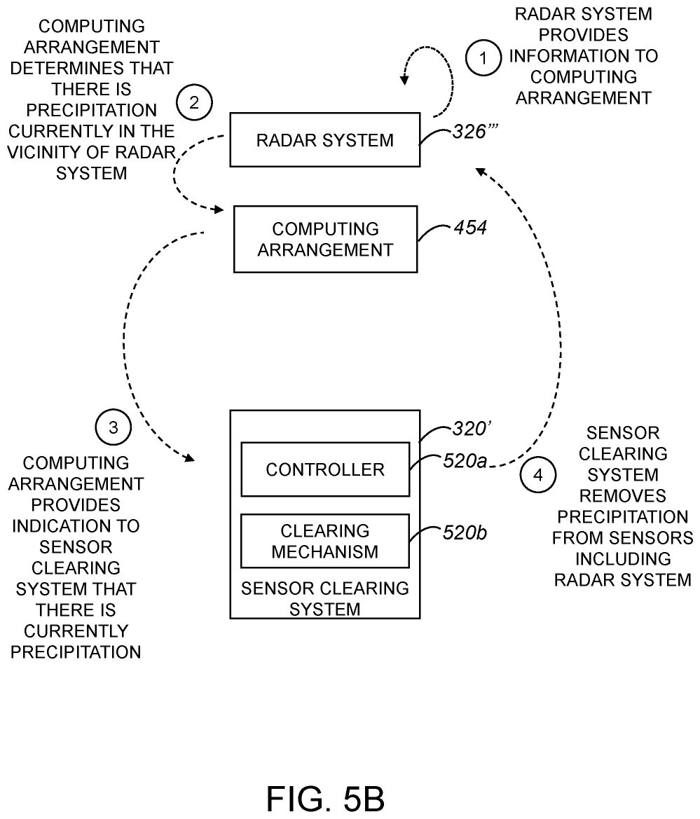

When a precipitation detection arrangement, as for example precipitation detection arrangement 450c of FIG. 4B or precipitation detection arrangement 458 of FIG. 4C, detects or otherwise identifies precipitation, a sensor clearing process may effectively be triggered or otherwise initiated. Referring next to FIG. 5A, a radar system, e.g., radar system 326 of FIG. 3, and a sensor clearing system that may be triggered by the radar system which includes a precipitation detection arrangement will be described in accordance with an embodiment. A radar system 326 determines, or otherwise senses, at a time t1 that there is currently precipitation in its vicinity. Such a determination may be made using a precipitation detection system that is effectively a part of radar system 326.

At a time t2, radar system 326 provides an indication, e.g., a signal, to a controller 520a of sensor clearing system 320′ which indicates that there is currently precipitation. Upon obtaining the notification from radar system 326, sensor clearing system 320′ may activate a clearing mechanism 520b at a time t3 to remove precipitation from sensors. In the described embodiment, sensors from which precipitation may be removed include radar system 326. Clearing mechanism 520b may include, but is not limited to including, a fan arranged to blow or circulate air, a nozzle arranged to dispense a clearing fluid, and/or a heating mechanism configured to cause precipitation to evaporate.

With reference to FIG. 5B a radar system and a computing arrangement, e.g., radar system 326′″ and computing arrangement 454 of FIG. 4C, that may trigger a sensor leaning system will be described in accordance with an embodiment. At a time t1, radar system 326′″ may provide information to computing arrangement 454. The information provided may be information obtained from a receiver, e.g., receiver 446 of FIG. 4C.

At a time t2, computing arrangement 454 determines, using information or data provided by radar system 326′″, that there is precipitation that is currently in the vicinity of radar system 326′″. Computing arrangement 454 provides an indication to sensor clearing system 320′ or, more specifically, to controller 520a, at a time t3 which indicates that there is currently precipitation. At a time t4, sensor clearing system 320′ activates clearing mechanism 520b to remove precipitation from sensors including, in the described embodiment, radar system 326′″.

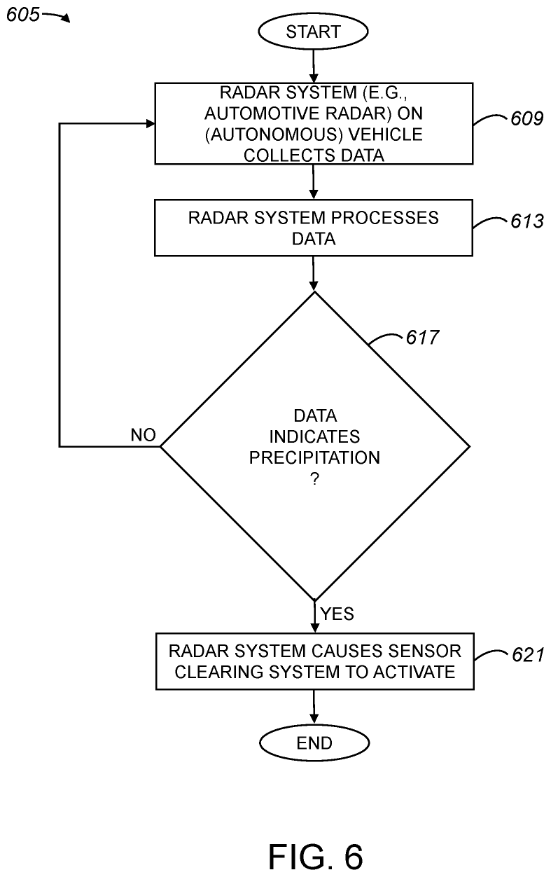

A radar system which includes one or more automotive radar units may detect a presence of precipitation such as rain, snow, hail, and/or sleet, as discussed above. FIG. 6 is a process flow diagram which illustrates a method of utilizing a radar system to detect a presence of precipitation and to trigger sensor clearing in accordance with an embodiment. A method 605 of utilizing a radar system to trigger sensor clearing begins at a step 605 in which a radar system, e.g., a radar system suitable for use in automotive systems, on a vehicle collects data. The radar system may include one or more radar units, and the radar units may be positioned substantially anywhere on the vehicle. As will be appreciated by those skilled in the art, collecting data may include transmitting radio waves and receiving reflected radio waves.

In a step 613, the radar system processes collected data. Processing collected data may include, but is not limited to including, determining whether precipitation is indicated and ascertaining whether there are objects in the vicinity of the vehicle, and, when there are objects in the vicinity of the vehicle, determining whether the objects are moving as well as the speed and the direction of movement.

The presence of precipitation such as rain, snow, sleet, and/or hail generally causes a relatively predictable distortion on a detected object or target, e.g., a detected vehicle or pedestrian. Thus, when there is a distortion on a detected object, the indication may be that precipitation is present. Identifying a distortion may be accomplished, in one embodiment, by training or otherwise using machine learning to perform pattern recognition relating to distortions. Techniques such as digital signal processing techniques may be used to match a signature of a distortion, or noise, due to precipitation to patterns in the collected data.

In general, precipitation such as rain has a measurable velocity or speed, and a radar system may substantially directly measure the radial velocity of a detected object. The radar system may detect the velocity of rain falling relative to the vehicle on which the radar system is mounted and/or relative to the motion of the vehicle, and utilize the signature of the rain to differentiate the rain from other potential sources of distortion, or noise.

Rain, snow, sleet, and/or hail may effectively cause, or be characterized as, background noise with a particular signature within data collected by a radar system and processed to detect the presence of objects. The radar system may be calibrated based on the particular signature which indicates background noise in order to determine the presence, as well as the amount, of rain, snow, sleet, and/or hail.

After the radar system processes collected data in step 613, a determination is made as to whether the collected data indicates the presence of precipitation in a step 617. Such a determination may include, but is not limited to including, ascertaining whether the particular signature of a type of precipitation was identified when the collected data was processed.

If the determination in step 617 is that the collected data does not indicate the presence of precipitation, then process flow returns to step 609 in which the radar system continues to collect data. Alternatively, if it is determined in step 617 that the data indicates the presence of precipitation, the radar system causes a sensor clearing system to activate in a step 621. When activated, the sensor clearing system clears precipitation from the surface of at least one sensor. Causing the sensor clearing system to activate may include, but is not limited to including, sending a signal to the sensor clearing system to trigger the sensor clearing system, as well as providing other information that may facilitate the operation of the sensor clearing system, e.g., information that indicates a type and amount of precipitation. Although the sensor clearing system may generally be activated based on a set of predetermined parameters, e.g., an amount of air to blow and a speed of a fan arranged to cause air to blow, it should be appreciated that in some instances, the clearing system may have different sets of predetermined parameters which are effectively selected based upon factors including, but not limited to including, an amount of precipitation detected and/or a type of precipitation detected. The method of utilizing a radar system to trigger sensor clearing is completed once the sensor clearing system is activated.

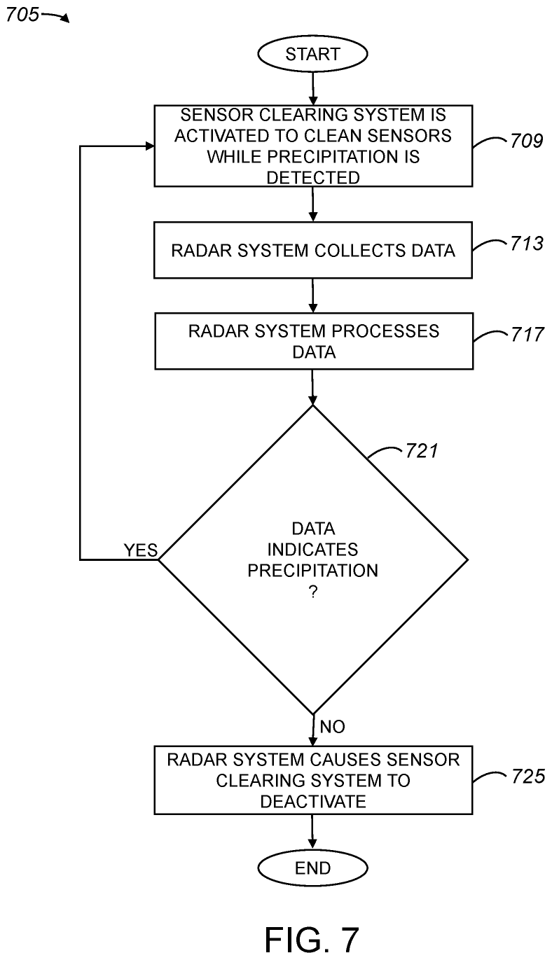

FIG. 7 is a process flow diagram which illustrates a method of utilizing a radar system detect a lack of precipitation in accordance with an embodiment. A method 705 of utilizing a radar system to determine when to deactivate a sensor clearing system begins at a step 709 in which a sensor clearing system is activated, or otherwise in use, to clear surfaces of one or more sensors while precipitation is detected or currently present.

In a step 713, a radar system collects data. It should be appreciated that while the data is collected, the sensor clearing system is activated. The radar system processes the collected data in a step 717 to identify the presence of objects as well as the presence of particular signatures which indicate the presence or precipitation.

It is determined in a step 721 whether the collected data indicates the presence of precipitation. If the determination is that precipitation is present, process flow returns to step 709 in which the sensor clearing system continues to be activated or in use.

Alternatively, if it is determined in step 721 that the collected data indicates the precipitation is no longer present, the implication is that the sensor clearing system no longer needs to be activated. Accordingly, in a step 725, the radar system causes the sensor clearing system to deactivate. Causing the sensor clearing system to deactivate may include, but is not limited to including, sending a signal to the sensor clearing system which indicates that the sensor clearing system is to terminate or otherwise cease clearing processes. Once the sensor clearing system is deactivated, the process of utilizing a radar system to determine when to deactivate a sensor clearing system is completed.

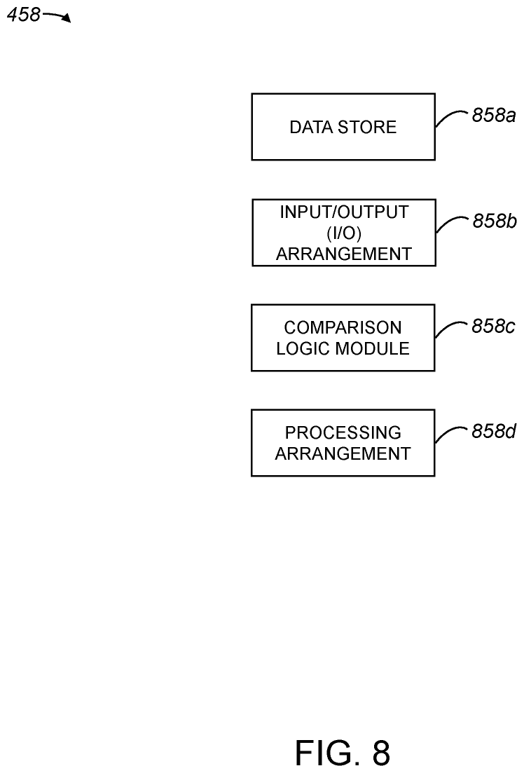

In general, a computing arrangement that includes a precipitation recognition arrangement may be provided with data obtained by a radar system on a vehicle. The precipitation recognition arrangement may process the data to ascertain whether precipitation is identified by the data, e.g., whether a signature associated with the data indicates a presence of precipitation. That is, a precipitation recognition arrangement may cooperate with a radar system to determine whether the radar system is detecting precipitation. FIG. 8 is a block diagram representation of a precipitation recognition arrangement, e.g., precipitation recognition arrangement 458 of FIG. 4C, in accordance with an embodiment. Precipitation recognition arrangement 458 includes a data store 858a, an input/output (I/O) or communications arrangement 858b, a comparison logic module 858c, and a processing arrangement 858d.

Data store 858a may be a data storage arrangement such as a database. Information, e.g., signatures, which are indicative of particular conditions may be stored in data store 858a. The signatures may be stored such that information which indicates the conditions associated with the signatures is available. The information stored in data store 858a may be obtained by comparison logic module 858c after data obtained by a radar system is obtained using I/O arrangement 858b. The data obtained by a radar system may be compared by comparison logic module 858c to information stored in data store 858a to determine whether the data matches information stored in data store 858a and, if the data matches information stored in data store 858a, whether the data indicates the presence of precipitation. Processing arrangement 8858d cooperates with comparison logic module 858c to process the data to identify a signature in the data that may be compared with information stored in data store 858a.

To obtain signatures which are indicative of particular conditions or situations, as for example signatures which indicate relatively heavy rain as detected by a radar system, data may be collected and analyzed. Once the data is collected and analyzed, and signatures are effectively identified and may be stored in a data store such as data store 858a of FIG. 8. Analyzing data to determine signatures which may be considered to be “standard” signatures for comparison purposes generally includes, but is not limited to including, collecting the data and tracking the conditions under which the data is collected. For example, data collected when there is heavy precipitation may be identified as being associated with a condition that involves relatively heavy precipitation, and the signature of the data may be identified as a signature which is indicative of relatively heavy precipitation.

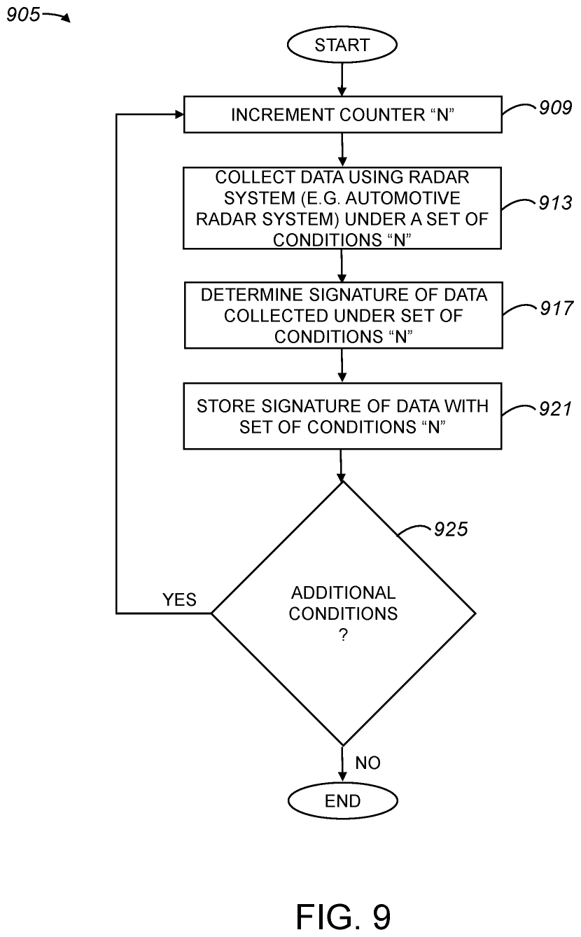

FIG. 9 is a process flow diagram which illustrates a method of obtaining signatures for comparison purposes, e.g., for use as benchmarking data, in accordance with an embodiment. A method 905 of obtaining and processing data for comparison purposes begins at a step 909 in which a counter “N” is incremented. Once the counter is incremented, data is collected using a radar system, e.g., an automotive radar system, under a set of conditions “N” in a step 913. In other words, data is collected under a set of conditions identified as set “N.” The set of conditions may vary widely and may include, but is not limited to including, a type of precipitation, an amount of precipitation, a relative velocity at which the precipitation detected by the radar system is falling, an angle at which the precipitation is falling, an environmental temperature, a size of a radar return for each droplet, and/or a number of radar returns.

In a step 917, the signature of the data collected under the set of conditions “N” is determined or otherwise identified. Such a determination or identification may involve parsing the data to identify characteristics in the data that are typically not present when, for example, there is no precipitation. Determining the signature of the data may also include applying signal processing techniques to mitigate any noise or interference in the collected data. Machine learning, pattern detection, and other techniques may also be implemented to facilitate the characterization of the signature. After the signature of the data is determined, the signature of the data is stored with the set of conditions “N” in a step 921. The signature and the corresponding conditions “N” may be stored in any suitable data storage mechanism such as a data store of a precipitation recognition arrangement.

From step 921, process flow moves to a step 925 in which it is determined whether there are additional conditions for which data is to be collected. In other words, it is determined if more data is to be collected using the radar system. If it is determined that data is to be collected, process flow returns to step 909 in which counter “N” is incremented. Alternatively, if the determination in step 925 is there are no additional conditions for which data is to be collected, then the method of obtaining and processing data for comparison purposes is completed.

It should be understood that while signal processing techniques may be applied to a comparison against characterized signatures, signal processing may instead involve a mathematical model, e.g., a model developed through machine learning, that utilizes radar detection data as input and outputs a probability or a classification relating to a probability, for example, that rain above a particular intensity exists, that a particular classified precipitation is highly likely to be a given type of precipitation, etc. That is, signal processing may be used with respect to a mathematical model to essentially characterize precipitation.

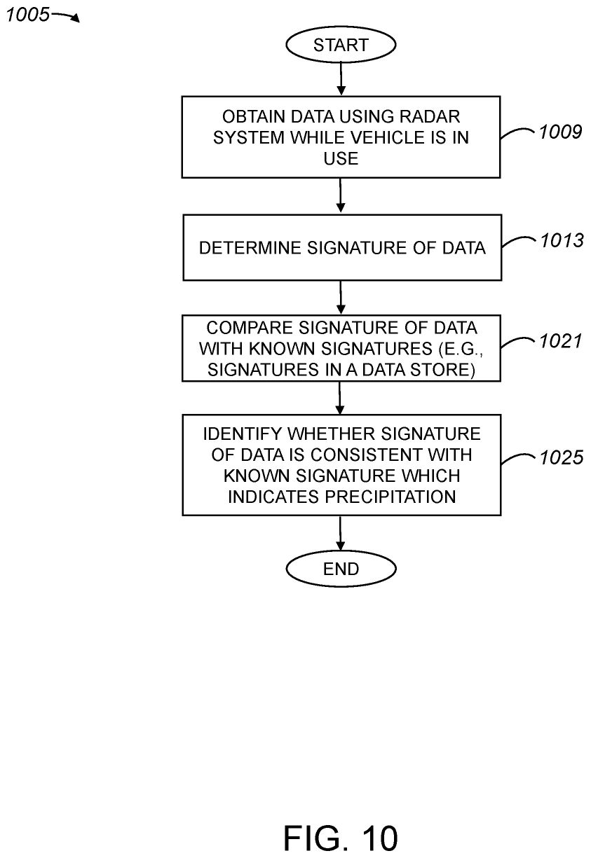

Signatures obtained for comparison purposes may be used to effectively determine whether data collected by a radar system of an autonomous vehicle while the autonomous vehicle is driving indicates the presence of precipitation. FIG. 10 is a process flow diagram which illustrates a method of identifying whether data collected from a radar system is indicative of a presence of precipitation in accordance with an embodiment. A method 1005 of identifying whether data collected from a radar system indicates a presence of precipitation begins at a step 1009 in which data is obtained using a radar system of a vehicle while the radar system is in use. The data may generally be used by a perception system to determine whether there are objects in the vicinity of the vehicle, and may also be provided to a precipitation recognition arrangement for processing.

In a step 1013, a signature of the data is determined, as for example through the application of signal processing methods. The signature of the data is compared with known signatures, e.g., signatures in a data store, in a step 1021, and an identification is made in a step 1025 as to whether the signature of the data is consistent with, e.g., substantially matches, a known signature which indicates precipitation. The identification may either be that the signature of the data indicates precipitation or that the signature of the data indicates a lack of precipitation. After the identification is made, the method of identifying whether data collected from a radar system indicates a presence of precipitation is completed.

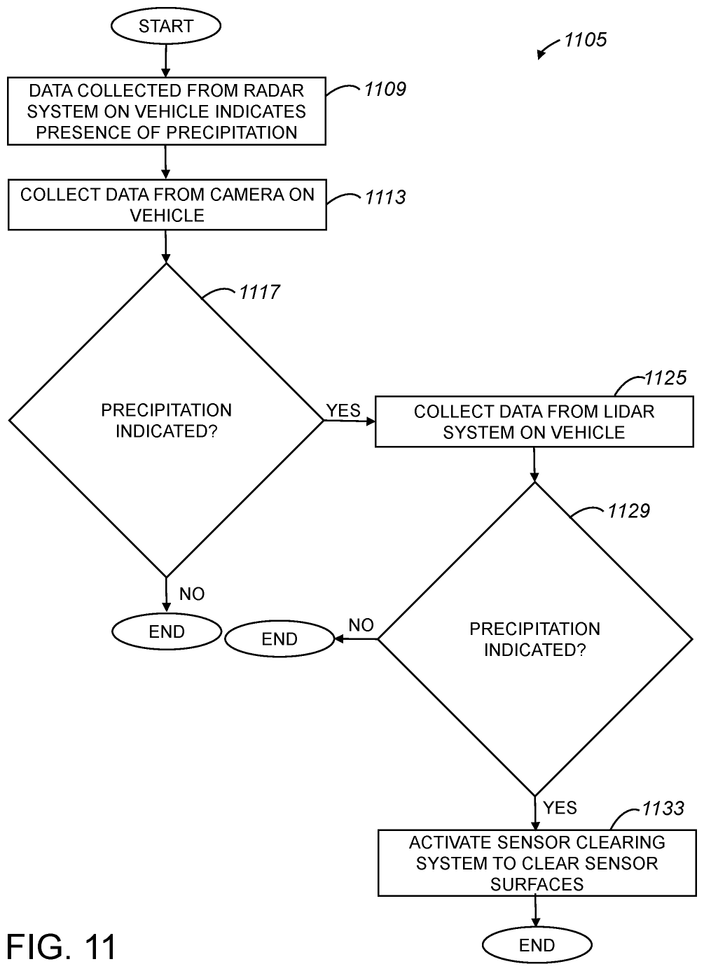

To increase the accuracy with which precipitation may be detected, a radar system may be used in conjunction with other sensors on a vehicle to determine whether precipitation is present. FIG. 11 is a process flow diagram which illustrates a method of using a radar system as part of an overall system which activates sensor clearing when precipitation is present in accordance with an embodiment. A method 1105 of detecting precipitation using an overall system which includes a radar system begins at a step 1109 in which data collected from a radar system on a vehicle indicates a presence of precipitation. The data may have a signature which is consistent with precipitation being present.

In a step 1113, data is collected from a camera on the vehicle. The data may be collected after the radar system effectively indicates the presence or precipitation. A controller on the vehicle may be used to obtain data from the camera for purposes of identifying whether precipitation is present. In one embodiment, the obtained data may be processed by a precipitation recognition arrangement such as precipitation recognition arrangement 458 of FIG. 4C.

A determination is made in a step 1117 as to whether precipitation is indicated by the data obtained from the camera. If the indication is that precipitation is not indicated, the implication is that the data collected from the radar system may be a false positive for precipitation, and the method of detecting precipitation using an overall system which includes a radar system is completed.

Alternatively, if it is determined in step 1117 that precipitation is indicated by the data obtained from the camera, data is collected from a lidar system on the vehicle in a step 1125. In the described embodiment, both a camera and a lidar system are used to detect precipitation, although it should be appreciated that in some instances, a camera or a lidar system may be used. That is, a camera, a lidar system, and/or both a camera and a lidar system may be used to effectively verify whether there is precipitation.

From step 1125, process flow proceeds to a step 1129 in which it is determined whether data collected from the lidar system indicates precipitations. If the determination is that precipitation is not indicated, then the method of detecting precipitation using an overall system which includes a radar system is completed. Alternatively, if it is determined in step 1129 that precipitation is indicated, then a sensor clearing system is activated in a step 1133 to clear sensor surfaces, and the method of detecting precipitation using an overall system which includes a radar system is completed.

Although only a few embodiments have been described in this disclosure, it should be understood that the disclosure may be embodied in many other specific forms without departing from the spirit or the scope of the present disclosure. By way of example, the type of radar system used to detect precipitation in the vicinity of the radar system may vary and is not limited to being an FMCW radar. Substantially any radar system which may be used to detect current precipitation near, or on, the radar system may be used to detect precipitation and to subsequently activate a sensor clearing system.

In one embodiment, sensors such as a wheel encoder and or an inertial measurement unit (IMU) sensor may be used for pose estimation associated with a vehicle. When there is wheel slippage on a vehicle due to wet surfaces, e.g., wet road surfaces, pose estimation using a wheel encoder and/or an IMU sensor may result in discrepancies which may be used to facilitate or enhance the detection of precipitation.

A radar system may generally include any suitable number of radar units, and radar units may be positioned substantially anywhere on a vehicle. Each radar unit may include a transmitter, a receiver, and a processing arrangement. A sensor clearing system that may effectively be activated or otherwise begin operating may also include any number of clearing units, and may be positioned substantially anywhere on a vehicle. It should be appreciated that any number of radar units may be used to detect the presence of precipitation, and that any number of clearing units may be triggered to clear surfaces of sensors.

As mentioned above, a radar system used to detect the presence of current precipitation may trigger a sensor clearing process that clears sensors including the radar system. In some embodiments, the radar system is not cleared by a sensor clearing process. More generally, the number of sensors cleared by a sensor clearing system may vary. For instance, a subset of sensors on a vehicle may be cleared, or substantially all sensors on a vehicle may be cleared, when precipitation is detected without departing from the spirit or the scope.

Different clearing mechanisms and, hence, methods may be used to clear surfaces of sensors. By way of example, a clearing mechanism used to clear rain from the surface of a sensor may be different from a clearing mechanism used to clear snow from the surface of the sensor. Alternatively, substantially the same clearing mechanism may be used to clear different types of precipitation from the surface of a sensor.

Further, clearing mechanisms may include any suitable components which are configured to clear precipitation from the surface of one or more sensors. As previously mentioned, clearing mechanisms may include, but are not limited to including, fans, nozzles which dispense fluid, and/or heating arrangements. In one embodiment, clearing mechanisms may also include one or more wipers.

In one embodiment, data collected while a vehicle is in use may be used to substantially refine stored data. That is, the signatures identified using data collected by a radar system while a vehicle is driving may be analyzed for accuracy and, if accurate, may effectively be used for comparison purposes.

A clearing system may use high velocity air and/or a centrifugal force to effectively remove moisture, e.g., water droplets, from a surface of a sensor. For example, radar may be used to detect rain, and the detection of the rain may activate a clearing system. A clearing system may run continuously, in one embodiment, when rain has been detected. A washer system configured to spray a liquid such as water to remove droplets such as rain droplets from the surface of a sensor may also, in some situations, run continuously.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, FIG. 11 describes a system which activates a sensor clearing system when data collected by a radar system, a camera, and a lidar system indicate that precipitation is present. In one embodiment, a system may activate a sensor clearing system when precipitation is detected by a radar system and a camera, or by a radar system and a lidar system. That is, a sensor clearing system may be activated when a majority of sensors, or a predetermined number of sensors, detects the presence of precipitation. Therefore, the present examples are to be considered as illustrative and not restrictive, and the examples are not to be limited to the details given herein, but may be modified within the scope of the appended claims.

What is claimed is:

1. A vehicle comprising:
a sensor system, the sensor system including a radar system, the radar system configured to collect a first set of data;
a clearing system, the clearing system configured to clear at least one surface associated with the sensor system; and
a detection arrangement, the detection arrangement arranged to determine when the first set of data indicates a presence of precipitation; wherein when the detection arrangement determines at least that the first set of data indicates the presence of precipitation, the detection arrangement causes the clearing system to activate to clear the at least one surface.

2. The vehicle of claim 1 wherein the vehicle is an autonomous or semi-autonomous vehicle, and wherein the vehicle includes a navigation system, the navigation system being configured to cooperate with the sensor system to enable the vehicle to operate autonomously or semi-autonomously.

3. The vehicle of claim 2 wherein the detection arrangement is configured to process the first set of data to identify a first signature, and wherein the detection arrangement determines that the first set of data indicates the presence of precipitation when the first signature approximately matches a second signature, the second signature arranged to indicate an existence of precipitation.

4. The vehicle of claim 2 wherein the sensor system further includes a camera, the camera configured to obtain a second set of data, and wherein the detection arrangement is further configured to determine when the second set of data indicates the presence of precipitations, wherein when the detection arrangement determines that the first set of data indicates the presence of precipitation, the detection arrangement also determines that the second set of data indicates the presence of precipitation.

5. The vehicle of claim 2 wherein the sensor system further includes a lidar system, the camera configured to obtain a second set of data, and wherein the detection arrangement is further configured to determine when the second set of data indicates the presence of precipitations, wherein when the detection arrangement determines that the first set of data indicates the presence of precipitation, the detection arrangement also determines that the second set of data indicates the presence of precipitation.

6. The vehicle of claim 1 wherein the radar system includes at least one frequency-modulated-continuous-wave (FMCW) radar unit.

7. A platform comprising:
a vehicle, the vehicle including
a) a sensor system, the sensor system including a radar system, the radar system configured to collect a first set of data, and
b) a clearing system, the clearing system configured to clear at least one surface associated with the sensor system; and
a detection arrangement, the detection arrangement arranged to determine when the first set of data indicates a presence of precipitation; wherein when the detection arrangement determines that at least the first set of data indicates the presence of precipitation, the detection arrangement causes the clearing system to activate to clear the at least one surface.

8. The platform of claim 7 wherein the vehicle includes a communications arrangement, and wherein the communications arrangement is configured to provide the first set of data to the detection arrangement.

9. The platform of claim 7 wherein the vehicle is an autonomous or semi-autonomous vehicle, and wherein the vehicle includes a navigation system, the navigation system being configured to cooperate with the sensor system to enable the vehicle to operate autonomously or semi-autonomously.

10. The platform of claim 9 wherein the detection arrangement is configured to process the first set of data to identify a first signature, and wherein the detection arrangement determines that the first set of data indicates the presence of precipitation when the first signature approximately matches a second signature, the second signature arranged to indicate an existence of precipitation.

11. The platform of claim 10 wherein the detection arrangement includes a data store, and wherein the data store stores the second signature.

12. The platform of claim 9 wherein the sensor system further includes a camera, the camera configured to obtain a second set of data, and wherein the detection arrangement is further configured to determine when the second set of data indicates the presence of precipitations, wherein when the detection arrangement determines that the first set of data indicates the presence of precipitation, the detection arrangement also determines that the second set of data indicates the presence of precipitation.

13. The platform of claim 9 wherein the sensor system further includes a lidar system, the camera configured to obtain a second set of data, and wherein the detection arrangement is further configured to determine when the second set of data indicates the presence of precipitations, wherein when the detection arrangement determines that the first set of data indicates the presence of precipitation, the detection arrangement also determines that the second set of data indicates the presence of precipitation.

14. A method comprising:
collecting a first set of data from a radar system, the radar system being a part of a sensor system associated with a vehicle.
determining whether the first set of data indicates a presence of precipitation; and
activating a clearing system when it is determined that at least the first set of data indicates the presence of precipitation, wherein activating the clearing system causes a surface associated with the sensor system to be cleared.

15. The method of claim 14 wherein the vehicle is an autonomous or semi-autonomous vehicle.

16. The method of claim 15 wherein determining whether the first set of data indicates a presence of precipitation includes processing the first set of data to identify a first signature and determining whether the first signature approximately matches a second signature, the second signature arranged to indicate an existence of precipitation.

17. The method of claim 16 wherein when the first signature approximately matches the second signature, the first set of data is determined to indicate the presence or precipitation, and wherein.

18. The method of claim 15 wherein the sensor system further includes a camera, the camera configured to obtain a second set of data, and wherein the method further includes:
determining whether the second set of data indicates the presence of precipitation, wherein activating the clearing system when it is determined that at least the first set of data indicates the presence of precipitation includes activating the clearing system when the first set of data and the second set of data indicate the presence of precipitation.

19. The method of claim 15 wherein the sensor system further includes a lidar system, the lidar system configured to obtain a second set of data, and wherein the method further includes:
determining whether the second set of data indicates the presence of precipitation, wherein activating the clearing system when it is determined that at least the first set of data indicates the presence of precipitation includes activating the clearing system when the first set of data and the second set of data indicate the presence of precipitation.

20. The method of claim 14 wherein the radar system includes at least one frequency-modulated-continuous-wave (FMCW) radar unit.
